(19) United States
(12) Patent Application Publication
(10) Pub. No.: US 2024/0304191 A1
(43) Pub. Date: Sep. 12, 2024

(54) USING A SEMANTIC MODEL FOR EXTENDED REALITY DATA FOR NETWORK EFFICIENT OPERATIONS

(71) Applicant: QUALCOMM Incorporated, San Diego, CA (US)

(72) Inventors: Anantharaman Balasubramanian, San Diego, CA (US); Liangping Ma, San Diego, CA (US)

(21) Appl. No.: 18/181,668

(22) Filed: Mar. 10, 2023

(51) Int. Cl. G10L 19/005; G06V 20/40; G06V 20/70; G10L 15/18; G10L 15/197; G10L 19/16; G10L 25/57; H04N 19/89

(52) U.S. Cl. CPC G10L 19/005; G06V 20/41; G06V 20/70; G10L 15/1815; G10L 15/197; G10L 19/167; G10L 25/57; H04N 19/89

(57) ABSTRACT

Methods, systems, and devices for wireless communications are described. A user equipment (UE) and a media server may set up a communication session to support an extended reality (XR) application. The UE may receive an indication of a semantic model to use for processing data packets to be received at the UE. The semantic model is determinative of incomplete audio data based on a meaning of known audio data. The UE may receive a set of data packets that encodes a first portion of a sequence of audio data and generate, using the semantic model and one or more data packets of the set of data packets, a second portion of the sequence of audio data. The second portion is in addition to the first portion.

### FIELD OF TECHNOLOGY

The following relates to wireless communications, including using a semantic model for extended reality data for network efficient operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications systems may support communication of various types of data, including extended reality (XR) data, which may include both audio and visual data. Network reliability and latency are important metrics in supporting XR applications. XR data may be communicated via data packets, and in some cases, a packet may be lost due to network failure, congestion, etc. Techniques such as data retransmission (e.g., at the physical layer or at the application layer) may be applied to ensure that data is received by a receiving device.

### SUMMARY

The described techniques relate to improved methods, systems, devices, and apparatuses that support using a semantic model for extended reality data for network efficient operations. For example, the described techniques provide for a user equipment (UE) and a media server that may set up a communication session to support an extended reality (XR) application. The UE may receive an indication of a semantic model to use for processing data packets to be received at the UE. The semantic model is determinative of incomplete audio data based on a meaning of known audio data. The UE may receive a set of data packets that encodes a first portion of a sequence of audio data and generate, using the semantic model and one or more data packets of the set of data packets, a second portion of the sequence of audio data. The second portion is in addition to the first portion.

A method for wireless communications at a user equipment (UE) is described. The method may include receiving an indication of a semantic model to use for processing data packets to be received at the UE, where the semantic model is determinative of incomplete audio data based on a meaning of known audio data, receiving a set of data packets that encodes a first portion of a sequence of audio data, and generating, using the semantic model and one or more data packets of the set of data packets, a second portion of the sequence of audio data, where the second portion is in addition to the first portion.

An apparatus for wireless communications at a UE is described. The apparatus may include a processor, memory coupled with the processor, and instructions stored in the memory. The instructions may be executable by the processor to cause the apparatus to receive an indication of a semantic model to use for processing data packets to be received at the UE, where the semantic model is determinative of incomplete audio data based on a meaning of known audio data, receive a set of data packets that encodes a first portion of a sequence of audio data, and generate, using the semantic model and one or more data packets of the set of data packets, a second portion of the sequence of audio data, where the second portion is in addition to the first portion.

Another apparatus for wireless communications at a UE is described. The apparatus may include means for receiving an indication of a semantic model to use for processing data packets to be received at the UE, where the semantic model is determinative of incomplete audio data based on a meaning of known audio data, means for receiving a set of data packets that encodes a first portion of a sequence of audio data, and means for generating, using the semantic model and one or more data packets of the set of data packets, a second portion of the sequence of audio data, where the second portion is in addition to the first portion.

A non-transitory computer-readable medium storing code for wireless communications at a UE is described. The code may include instructions executable by a processor to receive an indication of a semantic model to use for processing data packets to be received at the UE, where the semantic model is determinative of incomplete audio data based on a meaning of known audio data, receive a set of data packets that encodes a first portion of a sequence of audio data, and generate, using the semantic model and one or more data packets of the set of data packets, a second portion of the sequence of audio data, where the second portion is in addition to the first portion.

Some examples of the method, apparatuses, and non-transitory computer-readable medium described herein may further include operations, features, means, or instructions for receiving an indication that one or more data packets encoding the sequence of audio data may have been dropped, where the second portion may be generated using the semantic model based on receiving the indication that one or more data packets may have been dropped.

In some examples of the method, apparatuses, and non-transitory computer-readable medium described herein, receiving the indication that the one or more data packets may have been dropped may include operations, features, means, or instructions for receiving, in one or more data packets of the received set of data packets, a field including the indication that the one or more data packets may have been dropped.

In some examples of the method, apparatuses, and non-transitory computer-readable medium described herein, the field includes a bit flag.

Some examples of the method, apparatuses, and non-transitory computer-readable medium described herein may further include operations, features, means, or instructions for decoding the received set of data packets to identify the first portion of the sequence of audio data and determining, based on decoding the received set of data packets, that one or more data packets encoding the second portion may have not been decoded, where the second portion may be generated using the semantic model based on determining that the one or more data packets may have not been decoded.

Some examples of the method, apparatuses, and non-transitory computer-readable medium described herein may further include operations, features, means, or instructions for refraining from transmitting a retransmission request for the one or more data packets encoding the second portion.

Some examples of the method, apparatuses, and non-transitory computer-readable medium described herein may further include operations, features, means, or instructions for receiving, in one or more data packets of the set of data packets, an indication that the one or more data packets may be usable to generate the second portion using the semantic model, where the second portion may be generated using the semantic model based on receiving the indication that the one or more data packets may be usable.

In some examples of the method, apparatuses, and non-transitory computer-readable medium described herein, receiving the indication that the one or more data packets may be usable may include operations, features, means, or instructions for receiving, in the one or more data packets, a respective field including the indication that a corresponding data packet may be usable.

In some examples of the method, apparatuses, and non-transitory computer-readable medium described herein, generating the second portion may include operations, features, means, or instructions for using audio data of the first portion that may be prior to the second portion to generate the second portion using the semantic model.

Some examples of the method, apparatuses, and non-transitory computer-readable medium described herein may further include operations, features, means, or instructions for receiving a second set of data packets that encode a sequence of video data and generating the second portion based on processing the sequence of video data using the semantic model.

In some examples of the method, apparatuses, and non-transitory computer-readable medium described herein, the second portion may be generated based on an environment encoded in the sequence of video data, objects displayed in the environment, arrangements of objects displayed in the environment, or any combination thereof.

In some examples of the method, apparatuses, and non-transitory computer-readable medium described herein, receiving the indication of the semantic model may include operations, features, means, or instructions for receiving the indication of the semantic model during a communication session setup procedure.

In some examples of the method, apparatuses, and non-transitory computer-readable medium described herein, receiving the indication of the semantic model may include operations, features, means, or instructions for receiving the indication of the semantic model via session initiation protocol (SIP) signaling.

In some examples of the method, apparatuses, and non-transitory computer-readable medium described herein, receiving the indication of the semantic model may include operations, features, means, or instructions for receiving the indication of an n-gram semantic model.

In some examples of the method, apparatuses, and non-transitory computer-readable medium described herein, the indication includes a value for n of the n-gram semantic model.

In some examples of the method, apparatuses, and non-transitory computer-readable medium described herein, receiving the indication of the semantic model may include operations, features, means, or instructions for receiving the indication of the semantic model that corresponds to a genre of music or a type of audio data.

In some examples of the method, apparatuses, and non-transitory computer-readable medium described herein, the sequence of audio data encodes music, sound effects, extended reality (XR) audio, or a combination thereof.

A method for wireless communications at a media server is described. The method may include outputting an indication of a semantic model to use for processing data packets to be received at a UE, where the semantic model is determinative of incomplete audio data based on a meaning of known audio data, encoding, using the semantic model, a sequence of audio data into a set of data packets, and outputting at least a subset of the set of data packets.

An apparatus for wireless communications at a media server is described. The apparatus may include a processor, memory coupled with the processor, and instructions stored in the memory. The instructions may be executable by the processor to cause the apparatus to output an indication of a semantic model to use for processing data packets to be received at a UE, where the semantic model is determinative of incomplete audio data based on a meaning of known audio data, encode, using the semantic model, a sequence of audio data into a set of data packets, and output at least a subset of the set of data packets.

Another apparatus for wireless communications at a media server is described. The apparatus may include means for outputting an indication of a semantic model to use for processing data packets to be received at a UE, where the semantic model is determinative of incomplete audio data based on a meaning of known audio data, means for encoding, using the semantic model, a sequence of audio data into a set of data packets, and means for outputting at least a subset of the set of data packets.

A non-transitory computer-readable medium storing code for wireless communications at a media server is described. The code may include instructions executable by a processor to output an indication of a semantic model to use for processing data packets to be received at a UE, where the semantic model is determinative of incomplete audio data based on a meaning of known audio data, encode, using the semantic model, a sequence of audio data into a set of data packets, and output at least a subset of the set of data packets.

Some examples of the method, apparatuses, and non-transitory computer-readable medium described herein may further include operations, features, means, or instructions for outputting an indication that one or more data packets encoding the sequence of audio data may have been dropped.

In some examples of the method, apparatuses, and non-transitory computer-readable medium described herein, outputting the indication that the one or more data packets may have been dropped may include operations, features, means, or instructions for including, in one or more data packets of the output set of data packets, a field including the indication that the one or more data packets may have been dropped.

In some examples of the method, apparatuses, and non-transitory computer-readable medium described herein, the field includes a bit flag.

In some examples of the method, apparatuses, and non-transitory computer-readable medium described herein, encoding the sequence of audio data may include operations, features, means, or instructions for determining whether audio data of a first data packet of the set of data packets may be predictable using the semantic model and refraining from outputting the first data packet based on determining that the first data packet may be predictable.

In some examples of the method, apparatuses, and non-transitory computer-readable medium described herein, determining whether the audio data of the first data packet may be predictable may include operations, features, means, or instructions for determining whether a probability of predicting the audio data using one or more second data packets of the set of data packets as input into the semantic model exceeds a threshold probability.

Some examples of the method, apparatuses, and non-transitory computer-readable medium described herein may further include operations, features, means, or instructions for receiving, at a first layer of the media server and from a second layer, an indication to discard a first data packet of the set of data packets and refraining from outputting the first data packet based on receiving the indication to discard the first data packet.

In some examples of the method, apparatuses, and non-transitory computer-readable medium described herein, the second layer may be a radio resource control layer.

In some examples of the method, apparatuses, and non-transitory computer-readable medium described herein, outputting, in one or more data packets of the set of data packets, an indication that the one or more data packets may be usable to generate a portion of the sequence of audio data using the semantic model.

In some examples of the method, apparatuses, and non-transitory computer-readable medium described herein, outputting the indication that the one or more data packets may be usable may include operations, features, means, or instructions for including, in the one or more data packets, a respective field including the indication that a corresponding data packet may be usable.

In some examples of the method, apparatuses, and non-transitory computer-readable medium described herein, refraining, based on outputting the indication of the semantic model, from retransmitting one or more data packets of the set of data packets.

Some examples of the method, apparatuses, and non-transitory computer-readable medium described herein may further include operations, features, means, or instructions for determining, based on outputting the indication of the semantic model, that a retransmission request for one or more data packets of the set of data packets may be not received.

Some examples of the method, apparatuses, and non-transitory computer-readable medium described herein may further include operations, features, means, or instructions for outputting a second set of data packets that encode a sequence of video data, where the semantic model may be configured to process the sequence of video data to generate a portion of the sequence of audio data.

In some examples of the method, apparatuses, and non-transitory computer-readable medium described herein, outputting the indication of the semantic model may include operations, features, means, or instructions for outputting the indication of the semantic model during a communication session setup procedure.

In some examples of the method, apparatuses, and non-transitory computer-readable medium described herein, outputting the indication of the semantic model may include operations, features, means, or instructions for outputting the indication of the semantic model via session initiation protocol (SIP) signaling.

In some examples of the method, apparatuses, and non-transitory computer-readable medium described herein, outputting the indication of the semantic model may include operations, features, means, or instructions for outputting the indication of an n-gram semantic model.

In some examples of the method, apparatuses, and non-transitory computer-readable medium described herein, the indication includes a value for n of the n-gram semantic model.

In some examples of the method, apparatuses, and non-transitory computer-readable medium described herein, outputting the indication of the semantic model may include operations, features, means, or instructions for outputting the indication of the semantic model that corresponds to a genre of music or a type of audio data.

In some examples of the method, apparatuses, and non-transitory computer-readable medium described herein, the sequence of audio data encodes music, sound effects, extended reality (XR) audio, or a combination thereof.

### BRIEF DESCRIPTION OF THE DRAWINGS

FIG. 1 illustrates an example of a wireless communications system that supports using a semantic model for extended reality data for network efficient operations in accordance with one or more aspects of the present disclosure.

FIG. 2 illustrates an example of a wireless communications system that supports using a semantic model for extended reality data for network efficient operations in accordance with one or more aspects of the present disclosure.

FIG. 3 illustrates an example of a process flow that supports using a semantic model for extended reality data for network efficient operations in accordance with one or more aspects of the present disclosure.

FIGS. 4 and 5 illustrate block diagrams of devices that support using a semantic model for extended reality data for network efficient operations in accordance with one or more aspects of the present disclosure.

FIG. 6 illustrates a block diagram of a communications manager that supports using a semantic model for extended reality data for network efficient operations in accordance with one or more aspects of the present disclosure.

FIG. 7 illustrates a diagram of a system including a device that supports using a semantic model for extended reality data for network efficient operations in accordance with one or more aspects of the present disclosure.

FIGS. 8 and 9 illustrate block diagrams of devices that support using a semantic model for extended reality data for network efficient operations in accordance with one or more aspects of the present disclosure.

FIG. 10 illustrates a block diagram of a communications manager that supports using a semantic model for extended reality data for network efficient operations in accordance with one or more aspects of the present disclosure.

FIG. 11 illustrates a diagram of a system including a device that supports using a semantic model for extended reality data for network efficient operations in accordance with one or more aspects of the present disclosure.

FIGS. 12 through 15 illustrate flowcharts showing methods that support using a semantic model for extended reality data for network efficient operations in accordance with one or more aspects of the present disclosure.

### DETAILED DESCRIPTION

Wireless communications systems may support communication of various types of data, including extended reality (XR) data, which may include both audio and visual data. Network reliability and latency are important metrics in supporting XR applications. XR data may be communicated via data packets, and in some cases, a packet may be lost due to network failure, congestion, etc. Techniques such as data retransmission (e.g., at the physical layer or at the application layer) may be applied to ensure that data is received by a receiving device. For example, a user equipment (UE) may receive/decode a set of data packets, identify that a packet is missing, and request that the network retransmit the packet. These retransmission techniques require increased utilization of communication resources, and may result in reduced power efficiencies.

Techniques described herein support the use of a machine learning model at a UE to predict audio data that is associated with a dropped or missing packet. For example, a UE may be configured with a semantic machine learning model that is used to predict audio data corresponding to dropped or untransmitted data packets. A network may indicate, to the UE, the semantic model to use for a communication session (e.g., use of an XR application for a period). The semantic model may be configured for audio genres or types (e.g., type of music or gaming). The network may then transmit a set of packets, and the UE may identify that a packet is missing and use the semantic model to infer the audio data corresponding to the missing packet. In some cases, the network may purposefully drop (not transmit) a packet based on identifying that the packet may be inferred using the semantic model so as to save network resources. In such cases, the network may indicate to the UE that a packet is not transmitted and/or indicate that one or more transmitted packets are important for predicting the data of the missing packet. Additionally, the UE may use video data, in addition to audio data, to predict the missing audio data. As such, these techniques may support communication of XR data, while preventing or limiting the use of retransmission requests and retransmissions, which may result in reduced utilization of communication resources and improved reliability and efficiency in a wireless communications system. These and other techniques are described in further detail with respect to the figures.

Aspects of the disclosure are initially described in the context of wireless communications systems. Aspects of the disclosure are further described with respect to a wireless communications system illustrating communication of XR data for an XR application and a process flow diagram. Aspects of the disclosure are further illustrated by and described with reference to apparatus diagrams, system diagrams, and flowcharts that relate to using a semantic model for extended reality data for network efficient operations.

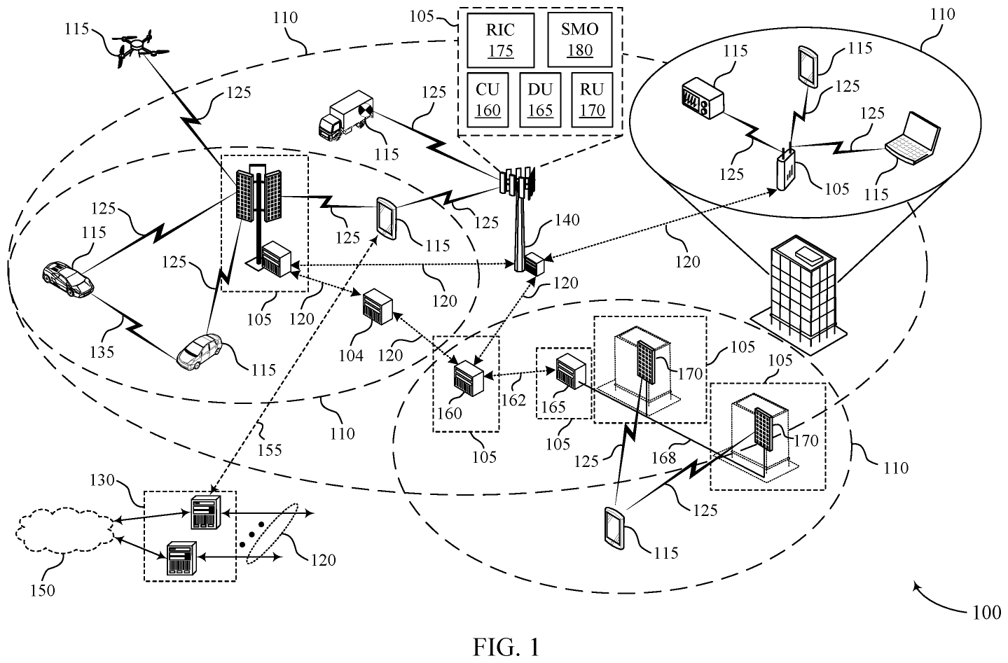

FIG. 1 illustrates an example of a wireless communications system 100 that supports using a semantic model for extended reality data for network efficient operations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support using a semantic model for extended reality data for network efficient operations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support communication of XR data between UEs 115 and network entities 105. XR data may be associated with games, music, augmented reality, and the like, and as such, XR data may include visual and audio data, as well as other types of data, such as spatial data, movement data. etc. Network reliability and latency are important metrics in support of XR applications. Further, XR data may be communicated via packets and packets may be lost or corrupted to network failure, congestion, etc. Techniques such as data retransmission (e.g., at the PHY layer or at the application layer) may be applied to ensure that data is received by a receiving device. For example, a UE 115 may receive/decode a set of data packets, identify that a packet is missing or is undecodable, and request that the network retransmit the packet. These retransmission techniques require increased utilization of communication resources, and may result in reduced power efficiencies.

Techniques described herein support the utilization of a machine learning model by network entities 105 and UEs 115 of the wireless communications system 200 to support prediction of data associated with packets that may not be transmitted successfully between a network entity 105 and a UE 115. For example, the network entity 105 may configure the UE 115 with a semantic model to use for processing data packets during a communication session (e.g., an XR application session). The UE 115 may receive a set of data packets that encode a first portion of a sequence of audio data, and the UE 115 may determine that a second portion is missing from the sequence based on a received indication, based on determining that a packet was dropped, etc. The UE 115 may use the semantic model and one or more packets of the received set of packets to predict the second portion of the sequence. In some examples, the network entity 105 may determine that a packet may be dropped from transmission (e.g., based on the corresponding data being predictable using the model) and indicate to the UE 115 that the packet is dropped. Additionally, or alternatively, the network entity 105 may indicate that one or more packets are usable to generate the second portion of audio data. Further, video data, in conjunction with the received audio data, may be used to decode the missing portion of audio data. Accordingly, the techniques described herein may support improved utilization of communication resources by reducing or limiting packet retransmissions.

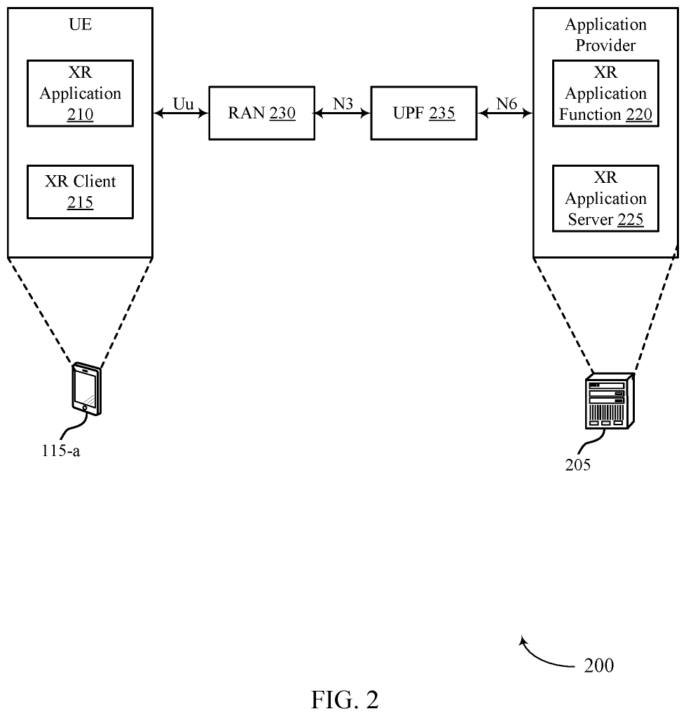

FIG. 2 illustrates an example of a wireless communications system 200 that supports using a semantic model for extended reality data for network efficient operations in accordance with one or more aspects of the present disclosure. The wireless communications system 200 includes a UE 115-a and an application provider 205. The UE 115-a may be an example of the UEs 115 described with respect to FIG. 1. The application provider 205 may represent aspects of the core network 130 or IP services 150 of FIG. 1. The wireless communications system 200 also includes RAN 230, which may represent aspects of the wireless communications system 100 of FIG. 1, such as one or more network entities 105. Additionally, the wireless communications system 200 includes a UPF 235, which may corresponds to an entity external to a core network that may function to routes packets, among other functions. For example, the UPF 235 is configured to transmit user data between endpoints (e.g., the UE 115-a and the application server 225) of the wireless communications system 200. The UPF 235 may perform related functions, such as packet filtering, traffic management, and data compression. The UPF 235 may be deployed at the core network or an edge network. The UE 115-a may communicate with the RAN 230 via a Uu interface, and the RAN 230 may communicate with the UPF 235 via a N3 interface. Additionally, the UPF 235 may communicate with other networks or systems, such as the application provider 205, via an N6 interface.

As described herein, the UE 115-a may execute an XR application 210, which uses an XR client 215 to communicate with the application provider 205. The application provider includes an application function 220 and an application server 225 (also referred to herein as a media server). The application function 220 may provide access to the XR services and may be configured to manage the access and delivery of XR data to end user devices, such as the UE 115-a. The application server 225 may be an example of an application server that is dedicated to XR services and content. The XR client 215 of the UE 115-a may represent an internal function that is dedicated to XR services.

Network latency and reliability are important metrics in supporting XR services. Techniques such as retransmission at different layers (e.g., PHY, application layer) may be applicable support reliability. However, some communications system may not be designed around the approach of bit-by-bit transmission but may be based on the ‘meaning’ of the underlying source that is being transmitted. This paradigm, sometimes referred to semantic communications, may rely on whether the received packet can convey the meaning (or to accomplish an objective), rather than looking for correct reception of each packet. Techniques described herein support the utilization of statistical models of language that are used in some systems (e.g., to predict missing word(s) in a sentence) in the context of the XR framework.

For example, the application provider 205 may provide media (e.g., audio and/or visual data) to the UE 115-a. When a UE media client loses a packet due to network outage, the UE 115 may request feedback (e.g., real-time transport control protocol (RTCP feedback)), which may incur delay, and XR applications may not function correctly with delay. For this tight delay bound scenario (e.g., XR), the techniques described herein support the UE 115-a semantically constructing the lost content without having to lose or limiting the reduction in the quality of the rendered content. In one example, the techniques described herein address the case of rendering spatial audio (with higher bit rate than conventional audio) in conjunction with the video. Further, the techniques described herein support the AR/MR application server encoding the media packets such that in the event that the UE 115-a loses a media packet (spatial audio/video), the UE 115-a is able to semantically reconstruct the media without looking to recover the lost packet from the network. Additionally, techniques described herein support signaling parameters provided by the media server (e.g., the application server 225) to the UE 115-a such that the UE 115-a is a able to recover the lost media semantically.

A semantic model may be used for different types of audio (e.g., spatial XR audio). The model may capture the grammar of sound effects that are allowed in a spatial XR audio sequence covering one or more genres of music in a probabilistic sense. In one example, an n-gram music model may be created for all different beats in a particular music genre/XR sound effect. In the n-gram music model, the current beat is modeled probabilistically by using its previous (n−1) beats. If bᵢ corresponds to beat i for a XR sound effect. The probability of obtaining a XR sound effect sequence b₁, b₂, . . . bn for a 3-gram model can be modeled as:

$$( {b}_{1} {b}_{2} … {b}_{n} ) = p ( {b}_{1} ) p ( {b}_{2} \vert {b}_{1} ) p ( {b}_{3} \vert {b}_{1} {b}_{2} ) p ( {b}_{4} \vert {b}_{2} {b}_{3} ) … p ( {b}_{n} \vert {b}_{n - 2} {b}_{n - 1} )$$

In order to obtain the above model, the following is determined by considering an ensemble of different XR sound effects or a genre (e.g., echo sound effects generated in a closed room):

$$p ( {b}_{1} ) , p ( {b}_{2} \vert {b}_{1} ) , p ( {b}_{3} \vert {b}_{1} {b}_{2} ) , … p ( {b}_{n} \vert {b}_{n - 1} {b}_{n - 2} )$$

In the event when sound effect prediction (e.g., using a 3-gram model) is to be performed due to lost packets, the model may use the latest two received sound beats: cₖ₋₁, cₖ. The next sound sequence cₖ₊₁ is predicted as:

$${c}_{k + 1} = arg {max}_{m} p ( {b}_{m} \vert {c}_{k - 1} , {c}_{k} ) .$$

If more sound sequences are to be predicted, (e.g., cₖ₊₂), in one case the sound sequence is predicted using a 3-gram model by using the correctly received cₖ and the previously predicted cₖ₊₁. i.e.,

$${c}_{k + 2} = arg {max}_{m} p ( {b}_{m} \vert {c}_{k + 1} , {c}_{k} ) .$$

In another example, cₖ₊₂ is predicted using a 4-gram model by using cₖ₋₁, cₖ, cₖ₊₁ (e.g.,

$${c}_{k + 2} = arg {max}_{m} p ( {b}_{m} \vert {c}_{k - 1} , {c}_{k} , {c}_{k + 1} ) ) .$$

As such, to support the UE 115-a using such a model, the application server 225 may provide an indication of the model to the UE 115-a for use in a communication session (e.g., during an XR application 210 session). In some examples, the network provides the indication of the semantic model during communication session setup, such as using the SIP protocol (e.g., for a video conferencing session). If the UE 115-a detects a lost packet corresponding to a sequence of audio data, the UE may utilize the decoded audio data to predict the missing data, as described herein.

In some examples, the application server 225 may support encoding of semantic dependence of packets. That is, the application server 225 may utilize different techniques of encoding by using the semantic model for the audio data. For example, the encoder of the application server 225 may use the semantic model to determine whether the sound effect (e.g., the portion of audio data) of the current packet may be predicted from the sound effect(s) (e.g., another portion of the audio data) of the last n packets (and possibly future m packets).

For example, letting bᵢ be the XR sound effect content of a current packet, if p(bᵢ|bᵢ₋₁, bᵢ₋₂)>THR, where THR is a preconfigured parameter of a 3 gram model, then the encoder determines that the current sound effects can be predicted. THR may correspond to a predictability threshold or a confidence score. If the content of the current packet satisfies the threshold (based on other data), then the application server 225 may utilize different techniques to transmit data to the UE 115-a. In some examples, the media encoder (e.g., at the application layer) discards the packet for which the prediction condition is satisfied (e.g., prediction probability of the current sound effect greater than the threshold), with the assumption that the current packet can be semantically reconstructed at the decoder at the receiver (e.g., the UE 115-a). Additionally, or alternatively, the media server may discard the current packet at the request of a 3GPP layer (e.g., RRC) possibly due to the network congestion. For example, the 3GPP layer may request that a packet is discarded, and the media server may select packets to discard based on the probability and/or satisfaction of the threshold.

In some cases, the media encoder indicates that one or more of the packets are dropped intentionally due to prediction potential ability (or network congestion). For example, the media encoder sets a bit in packet (k−1), or (k−2), etc., if packet k may be semantically reconstructed from the packets, and the bit may indicate that packet k has been intentionally dropped. This technique may save transmission resources without impacting XR effects. Additionally, or alternatively, the application server 225 may provide an indication of the importance of the current packet in performing semantic sound effect prediction for data corresponding to subsequent or other packets. For example, the effectiveness of the current packet bₖ is determined based on semantic prediction ability with and without the packet. If p(bₖ₊ₙ|bₖ₊ₙ₋₁,bₖ₊ₙ₋₂, bₖ₋₁)<THR1 (e.g., condition without packet bₖ), and if p(bₖ₊ₙ|bₖ₊ₙ₋₁,bₖ₊ₙ₋₂,bₖ₋₁,bₖ)>THR2, (condition with packet bₖ) this implies that packet bₖ is effective for future semantic prediction. In this case, the application server 225 enables a bit to signify the importance of the packet. That is, the application server may indicate that one or more packets are usable for semantic prediction using a bit in the one or more packets.

As described herein, the application server 225 may provide an indication of the n-gram model that is to be used by the UE 115-a for semantically reconstructing the lost packets. In some examples, the model is signaled by the application server 225 during setup of the communication session. In the case of a video conferencing session, the semantic model signaling may occur using the SIP protocol.

In some examples, the model may use a semantic dependence between audio and video to support audio data predicting or generation. In many cases, the video stream of XR content may be delivered properly. However, the corresponding audio may not be (or vice-versa). In one case, the spatial audio is semantically predicted based on video stream. For example, the scene of video XR content can be inside a closed room, in which case one can expect to create an artificial spatial sound “echo effect.” In this case the semantic model may be used to detect whether the video scene environment is indoor/outdoor, type and/or quantity of objects present in the video scene, spatial arrangement of the detected objects in the scene, etc. As such, based on the objects and environment detected from packet data, the model may predict audio data. In some examples, the spatial audio stream may be predicted in a hybrid manner. That is, spatial audio stream can be predicted based on accompanying video content as well as the semantic sound effect model discussed herein. Letting α₁, α₂ be the weight (importance) provided to the semantic video and semantic audio model, respectively. The predicted spatial audio in a simple case may be α₁bᵥ+α₂bₐ, where bᵥ, bₐ are predictions based on accompanying video, and audio, respectively. Thus, use of audio and video data of received packets may support improved performance and reliability in predicting audio data from lost or dropped audio data packets.

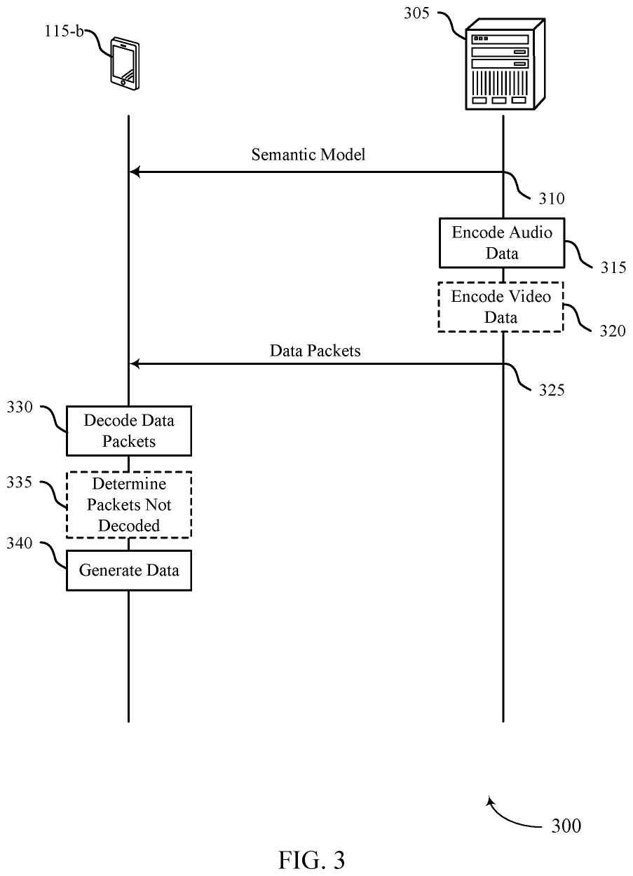

FIG. 3 illustrates an example of a process flow 300 that supports using a semantic model for extended reality data for network efficient operations in accordance with one or more aspects of the present disclosure. The process flow 300 includes a UE 115-b and a media server 305. The UE 115-b may be an example of the UEs 115 as described with respect to FIGS. 1 and 2, and the media server 305 may be an example of the application server 225 as described with respect to FIG. 2. In the following description of the process flow 300, the operations between UE 115-b and the media server 305 may be transmitted in a different order than the example order shown, or the operations performed may be performed in different orders or at different times. Some operations may also be omitted from the process flow 300, and other operations may be added to the process flow 300.

At 310, the media server 305 may output and the UE 115-b may receive an indication of a semantic model to use for processing data packets to be received at the UE. The semantic model is determinative of incomplete audio data based on a meaning of known audio data. For example, the semantic model may be trained on one or more different types of audio data (and video data, in some examples) and may be configured to determine a portion of audio data based on a known portion of audio data. In some examples, transmission of the indication of the semantic model may include transmitting an indication of weights, parameters, etc. of the semantic model. The indication of the semantic model may be received during a communication session setup procedure (e.g., using SIP signaling). The semantic model may be an n-gram semantic model, and the signaling may indicate the value for n. The indicated semantic model may correspond to a genre of music or type of audio data.

At 315, the media server 305 may encode, using the semantic model, a sequence of audio data into a set of data packets. At 320, the media server 305 may encode, using the semantic model a set of video data into a second set of data. While encoding the audio and/or video data, the media server 305 may determine whether audio data of a first data packet of the set of data packets is predictable using the semantic model. In some examples, based on using the semantic model, the media server 305 may include, in one or more data packets of the set of data packets, a field including the indication that the one or more data packets have been dropped. Additionally, or alternatively, the media server 305 may include, in the one or more data packets, an indication that the one or more data packets are usable to generate a portion of the sequence of audio data using the semantic model. That is, based on using the semantic model, the media server 305 may determine that the data (audio or video) of one or more packets is usable to predict the data of other packets, and as such, determine to drop the packet and indicate in other packets that the other packets may be used to determine the data of the packets.

At 325, the media server 305 may output, and the UE 115-b may receive a set of data packets that encodes a first portion of a sequence of audio data. At 330, the UE 115-b may decode the received set of data packets. At 335, the UE 115-b may determine that one or more packets have not been decoded. In some cases, the UE 115-b may receive an indication that one or more data packets encoding the sequence of audio data have been dropped. In some examples, one or more data packets of the received set of packets may include a field including the indication that the one or more data packets have been dropped. Additionally, or alternatively, the UE 115-b may determine that one or more packets are missing. Additionally, or alternatively, the UE 115-b may receive, in one or more data packets of the set of data packets, an indication (e.g., a field) that the one or more data packets are usable to generate the second portion using the semantic model. The sequence of audio data may encode music, sound effects, extended reality (XR) audio, or a combination thereof.

At 340, the UE 115-b may generate, using the semantic model and one or more data packets of the set of data packets, a second portion of the sequence of audio data. The second portion is in addition to the first portion. That is, the UE 115-b may reconstruct the audio semantically using a machine learning model. In some cases, the UE 115-b generates the second portion using the semantic model based at least in part on receiving the indication that one or more data packets have been dropped or based at least in part on receiving the indication that the one or more data packets are usable. In some examples, the UE 115-b receives a second set of data packets that encodes a sequence of video data and generates the second portion based on processing the video data using the semantic model. For example, the second portion is generated based at least in part on an environment encoded in the sequence of video data, objects displayed in the environment, arrangements of objects displayed in the environment, or any combination thereof. As such, the UE 115-b may also refrain from transmitting a retransmission request for the one or more data packets encoding the second portion.

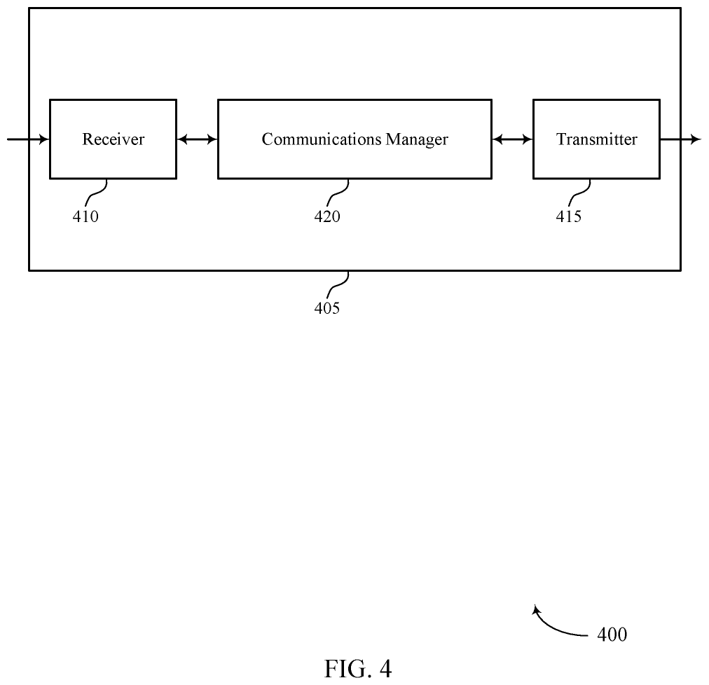

FIG. 4 illustrates a block diagram 400 of a device 405 that supports using a semantic model for extended reality data for network efficient operations in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to using a semantic model for extended reality data for network efficient operations). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to using a semantic model for extended reality data for network efficient operations). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of using a semantic model for extended reality data for network efficient operations as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for receiving an indication of a semantic model to use for processing data packets to be received at the UE, where the semantic model is determinative of incomplete audio data based on a meaning of known audio data. The communications manager 420 may be configured as or otherwise support a means for receiving a set of data packets that encodes a first portion of a sequence of audio data. The communications manager 420 may be configured as or otherwise support a means for generating, using the semantic model and one or more data packets of the set of data packets, a second portion of the sequence of audio data, where the second portion is in addition to the first portion.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for more efficient utilization of communication resources by reducing the need for retransmission request and retransmissions of packets based on being able to decode or predict audio data using a semantic model.

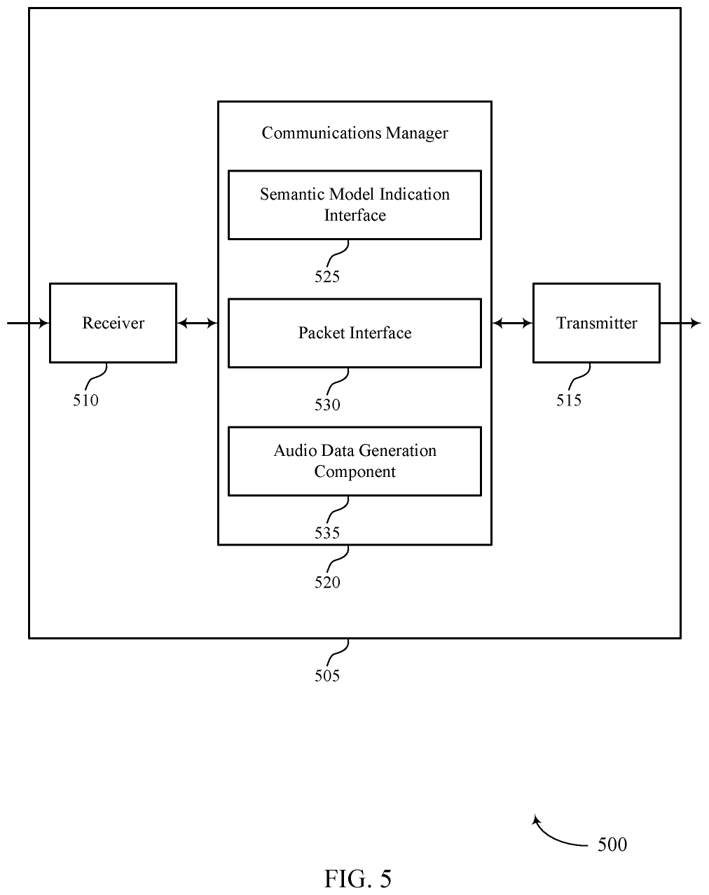

FIG. 5 illustrates a block diagram 500 of a device 505 that supports using a semantic model for extended reality data for network efficient operations in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to using a semantic model for extended reality data for network efficient operations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to using a semantic model for extended reality data for network efficient operations). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of using a semantic model for extended reality data for network efficient operations as described herein. For example, the communications manager 520 may include a semantic model indication interface 525, a packet interface 530, an audio data generation component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The semantic model indication interface 525 may be configured as or otherwise support a means for receiving an indication of a semantic model to use for processing data packets to be received at the UE, where the semantic model is determinative of incomplete audio data based on a meaning of known audio data. The packet interface 530 may be configured as or otherwise support a means for receiving a set of data packets that encodes a first portion of a sequence of audio data. The audio data generation component 535 may be configured as or otherwise support a means for generating, using the semantic model and one or more data packets of the set of data packets, a second portion of the sequence of audio data, where the second portion is in addition to the first portion.

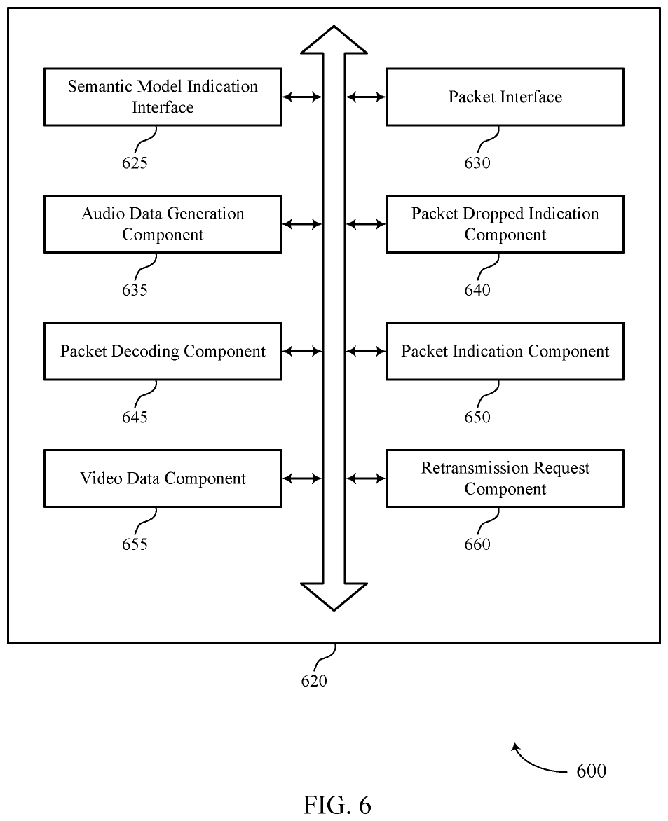

FIG. 6 illustrates a block diagram 600 of a communications manager 620 that supports using a semantic model for extended reality data for network efficient operations in accordance with one or more aspects of the present disclosure. The communications manager 620 may be an example of aspects of a communications manager 420, a communications manager 520, or both, as described herein. The communications manager 620, or various components thereof, may be an example of means for performing various aspects of using a semantic model for extended reality data for network efficient operations as described herein. For example, the communications manager 620 may include a semantic model indication interface 625, a packet interface 630, an audio data generation component 635, a packet dropped indication component 640, a packet decoding component 645, a packet indication component 650, a video data component 655, a retransmission request component 660, or any combination thereof. Each of these components may communicate, directly or indirectly, with one another (e.g., via one or more buses).

The communications manager 620 may support wireless communications at a UE in accordance with examples as disclosed herein. The semantic model indication interface 625 may be configured as or otherwise support a means for receiving an indication of a semantic model to use for processing data packets to be received at the UE, where the semantic model is determinative of incomplete audio data based on a meaning of known audio data. The packet interface 630 may be configured as or otherwise support a means for receiving a set of data packets that encodes a first portion of a sequence of audio data. The audio data generation component 635 may be configured as or otherwise support a means for generating, using the semantic model and one or more data packets of the set of data packets, a second portion of the sequence of audio data, where the second portion is in addition to the first portion.

In some examples, the packet dropped indication component 640 may be configured as or otherwise support a means for receiving an indication that one or more data packets encoding the sequence of audio data have been dropped, where the second portion is generated using the semantic model based on receiving the indication that one or more data packets have been dropped.

In some examples, to support receiving the indication that the one or more data packets have been dropped, the packet interface 630 may be configured as or otherwise support a means for receiving, in one or more data packets of the received set of data packets, a field including the indication that the one or more data packets have been dropped. In some examples, the field includes a bit flag.

In some examples, the packet decoding component 645 may be configured as or otherwise support a means for decoding the received set of data packets to identify the first portion of the sequence of audio data. In some examples, the packet decoding component 645 may be configured as or otherwise support a means for determining, based on decoding the received set of data packets, that one or more data packets encoding the second portion have not been decoded, where the second portion is generated using the semantic model based on determining that the one or more data packets have not been decoded.

In some examples, the retransmission request component 660 may be configured as or otherwise support a means for refraining from transmitting a retransmission request for the one or more data packets encoding the second portion.

In some examples, the packet indication component 650 may be configured as or otherwise support a means for receiving, in one or more data packets of the set of data packets, an indication that the one or more data packets are usable to generate the second portion using the semantic model, where the second portion is generated using the semantic model based on receiving the indication that the one or more data packets are usable.

In some examples, to support receiving the indication that the one or more data packets are usable, the packet indication component 650 may be configured as or otherwise support a means for receiving, in the one or more data packets, a respective field including the indication that a corresponding data packet is usable.

In some examples, to support generating the second portion, the audio data generation component 635 may be configured as or otherwise support a means for using audio data of the first portion that is prior to the second portion to generate the second portion using the semantic model.

In some examples, the video data component 655 may be configured as or otherwise support a means for receiving a second set of data packets that encode a sequence of video data. In some examples, the audio data generation component 635 may be configured as or otherwise support a means for generating the second portion based on processing the sequence of video data using the semantic model.

In some examples, the second portion is generated based on an environment encoded in the sequence of video data, objects displayed in the environment, arrangements of objects displayed in the environment, or any combination thereof.

In some examples, to support receiving the indication of the semantic model, the semantic model indication interface 625 may be configured as or otherwise support a means for receiving the indication of the semantic model during a communication session setup procedure.

In some examples, to support receiving the indication of the semantic model, the semantic model indication interface 625 may be configured as or otherwise support a means for receiving the indication of the semantic model via session initiation protocol (SIP) signaling.

In some examples, to support receiving the indication of the semantic model, the semantic model indication interface 625 may be configured as or otherwise support a means for receiving the indication of an n-gram semantic model.

In some examples, the indication includes a value for n of the n-gram semantic model.

In some examples, to support receiving the indication of the semantic model, the semantic model indication interface 625 may be configured as or otherwise support a means for receiving the indication of the semantic model that corresponds to a genre of music or a type of audio data.

In some examples, the sequence of audio data encodes music, sound effects, extended reality (XR) audio, or a combination thereof.

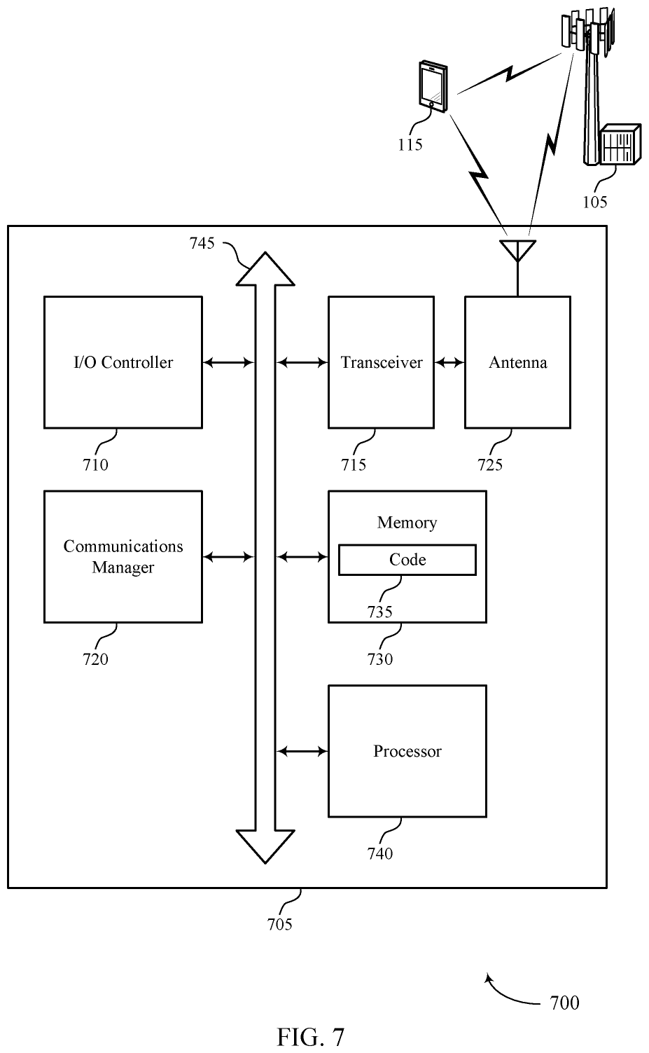

FIG. 7 illustrates a diagram of a system 700 including a device 705 that supports using a semantic model for extended reality data for network efficient operations in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting using a semantic model for extended reality data for network efficient operations). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving an indication of a semantic model to use for processing data packets to be received at the UE, where the semantic model is determinative of incomplete audio data based on a meaning of known audio data. The communications manager 720 may be configured as or otherwise support a means for receiving a set of data packets that encodes a first portion of a sequence of audio data. The communications manager 720 may be configured as or otherwise support a means for generating, using the semantic model and one or more data packets of the set of data packets, a second portion of the sequence of audio data, where the second portion is in addition to the first portion.

By including or configuring the communications manager 720 in accordance with examples as described herein, the device 705 may support techniques for more efficient utilization of communication resources by reducing the need for retransmission request and retransmissions of packets based on being able to decode or predict audio data using a semantic model. These techniques may result in improved battery life and battery consumption, among other benefits.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of using a semantic model for extended reality data for network efficient operations as described herein, or the processor 740 and the memory 730 may be otherwise configured to perform or support such operations.

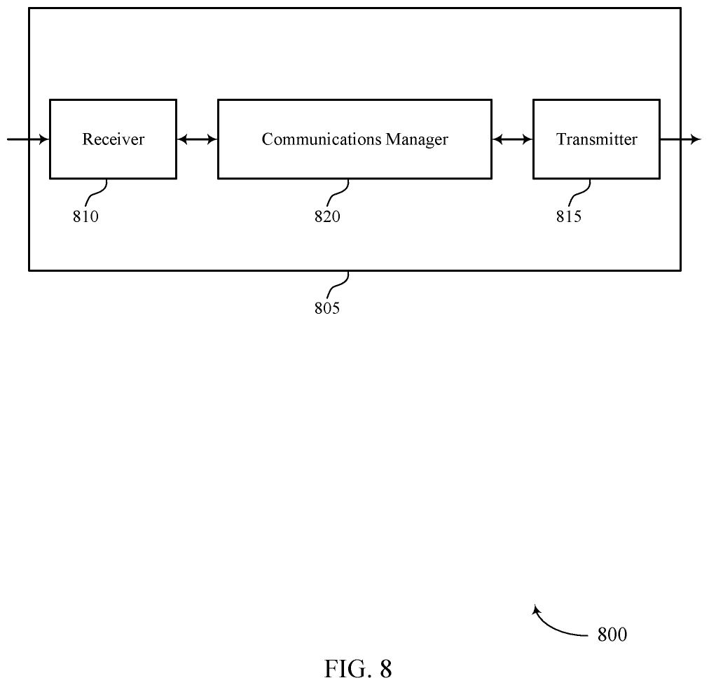

FIG. 8 illustrates a block diagram 800 of a device 805 that supports using a semantic model for extended reality data for network efficient operations in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of using a semantic model for extended reality data for network efficient operations as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a media server in accordance with examples as disclosed herein. For example, the communications manager 820 may be configured as or otherwise support a means for outputting an indication of a semantic model to use for processing data packets to be received at a UE, where the semantic model is determinative of incomplete audio data based on a meaning of known audio data. The communications manager 820 may be configured as or otherwise support a means for encoding, using the semantic model, a sequence of audio data into a set of data packets. The communications manager 820 may be configured as or otherwise support a means for outputting at least a subset of the set of data packets.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources by limiting or reducing the need for retransmission of data (e.g., audio data). By using the semantic model, the devices may generate or predict the audio data that corresponds to dropped, missing, or undecoded packets.

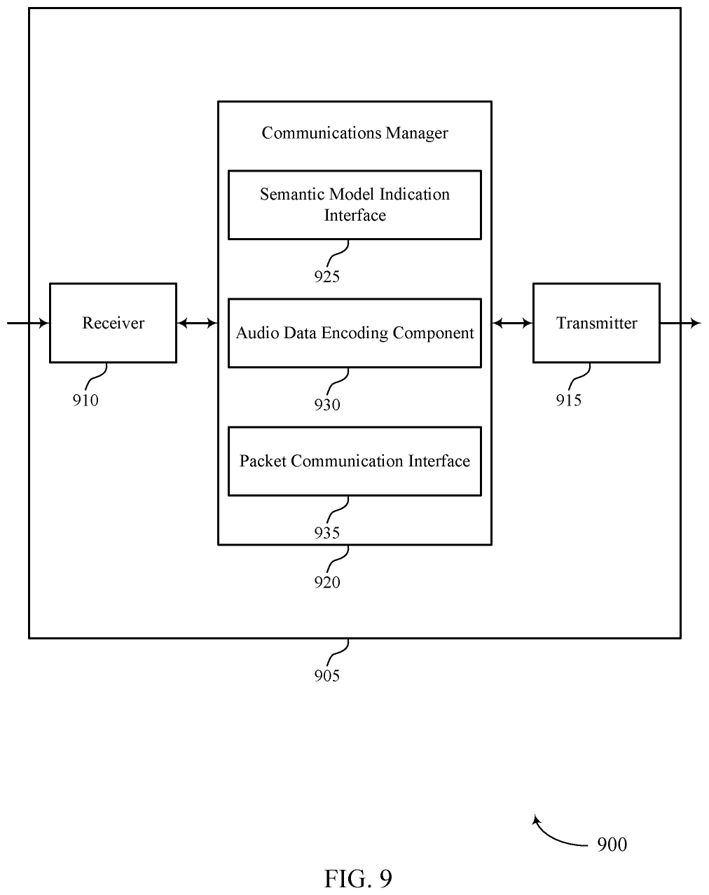

FIG. 9 illustrates a block diagram 900 of a device 905 that supports using a semantic model for extended reality data for network efficient operations in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of using a semantic model for extended reality data for network efficient operations as described herein. For example, the communications manager 920 may include a semantic model indication interface 925, an audio data encoding component 930, a packet communication interface 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a media server in accordance with examples as disclosed herein. The semantic model indication interface 925 may be configured as or otherwise support a means for outputting an indication of a semantic model to use for processing data packets to be received at a UE, where the semantic model is determinative of incomplete audio data based on a meaning of known audio data. The audio data encoding component 930 may be configured as or otherwise support a means for encoding, using the semantic model, a sequence of audio data into a set of data packets. The packet communication interface 935 may be configured as or otherwise support a means for outputting at least a subset of the set of data packets.

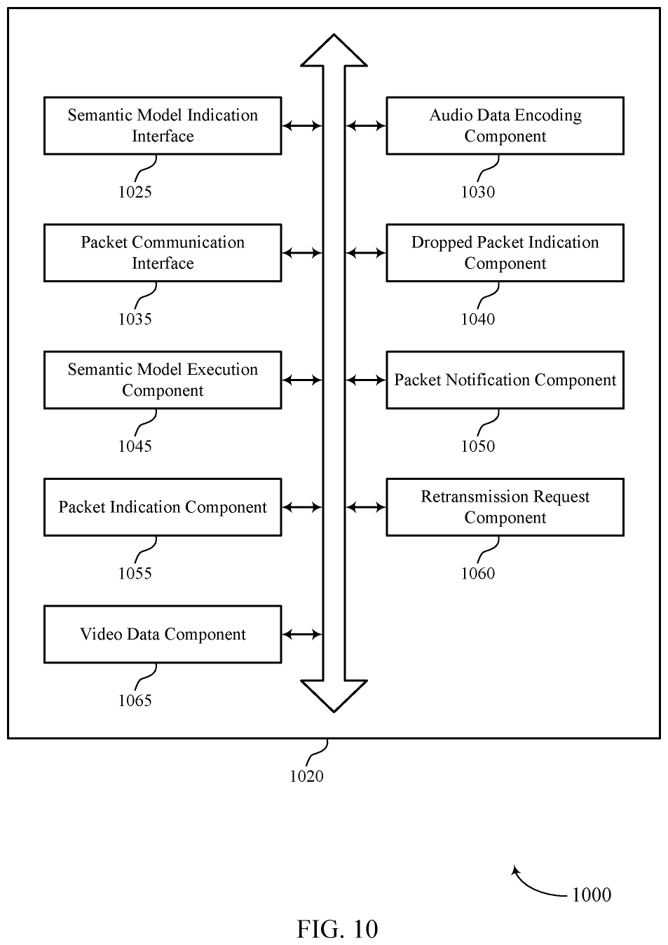

FIG. 10 illustrates a block diagram 1000 of a communications manager 1020 that supports using a semantic model for extended reality data for network efficient operations in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of using a semantic model for extended reality data for network efficient operations as described herein. For example, the communications manager 1020 may include a semantic model indication interface 1025, an audio data encoding component 1030, a packet communication interface 1035, a dropped packet indication component 1040, a semantic model execution component 1045, a packet notification component 1050, a packet indication component 1055, a retransmission request component 1060, a video data component 1065, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a media server in accordance with examples as disclosed herein. The semantic model indication interface 1025 may be configured as or otherwise support a means for outputting an indication of a semantic model to use for processing data packets to be received at a UE, where the semantic model is determinative of incomplete audio data based on a meaning of known audio data. The audio data encoding component 1030 may be configured as or otherwise support a means for encoding, using the semantic model, a sequence of audio data into a set of data packets. The packet communication interface 1035 may be configured as or otherwise support a means for outputting at least a subset of the set of data packets.

In some examples, the dropped packet indication component 1040 may be configured as or otherwise support a means for outputting an indication that one or more data packets encoding the sequence of audio data have been dropped.

In some examples, to support outputting the indication that the one or more data packets have been dropped, the dropped packet indication component 1040 may be configured as or otherwise support a means for including, in one or more data packets of the output set of data packets, a field including the indication that the one or more data packets have been dropped.

In some examples, the field includes a bit flag.

In some examples, to support encoding the sequence of audio data, the semantic model execution component 1045 may be configured as or otherwise support a means for determining whether audio data of a first data packet of the set of data packets is predictable using the semantic model. In some examples, to support encoding the sequence of audio data, the packet communication interface 1035 may be configured as or otherwise support a means for refraining from outputting the first data packet based on determining that the first data packet is predictable.

In some examples, to support determining whether the audio data of the first data packet is predictable, the semantic model execution component 1045 may be configured as or otherwise support a means for determining whether a probability of predicting the audio data using one or more second data packets of the set of data packets as input into the semantic model exceeds a threshold probability.

In some examples, the packet notification component 1050 may be configured as or otherwise support a means for receiving, at a first layer of the media server and from a second layer, an indication to discard a first data packet of the set of data packets. In some examples, the packet communication interface 1035 may be configured as or otherwise support a means for refraining from outputting the first data packet based on receiving the indication to discard the first data packet.

In some examples, the second layer is a radio resource control layer.

In some examples, the packet indication component 1055 may be configured as or otherwise support a means for outputting, in one or more data packets of the set of data packets, an indication that the one or more data packets are usable to generate a portion of the sequence of audio data using the semantic model.

In some examples, to support outputting the indication that the one or more data packets are usable, the packet indication component 1055 may be configured as or otherwise support a means for including, in the one or more data packets, a respective field including the indication that a corresponding data packet is usable.

In some examples, the packet communication interface 1035 may be configured as or otherwise support a means for refraining, based on outputting the indication of the semantic model, from retransmitting one or more data packets of the set of data packets.

In some examples, the retransmission request component 1060 may be configured as or otherwise support a means for determining, based on outputting the indication of the semantic model, that a retransmission request for one or more data packets of the set of data packets is not received.

In some examples, the video data component 1065 may be configured as or otherwise support a means for outputting a second set of data packets that encode a sequence of video data, where the semantic model is configured to process the sequence of video data to generate a portion of the sequence of audio data.

In some examples, to support outputting the indication of the semantic model, the semantic model indication interface 1025 may be configured as or otherwise support a means for outputting the indication of the semantic model during a communication session setup procedure.

In some examples, to support outputting the indication of the semantic model, the semantic model indication interface 1025 may be configured as or otherwise support a means for outputting the indication of the semantic model via session initiation protocol (SIP) signaling.

In some examples, to support outputting the indication of the semantic model, the semantic model indication interface 1025 may be configured as or otherwise support a means for outputting the indication of an n-gram semantic model.

In some examples, the indication includes a value for n of the n-gram semantic model.

In some examples, to support outputting the indication of the semantic model, the semantic model indication interface 1025 may be configured as or otherwise support a means for outputting the indication of the semantic model that corresponds to a genre of music or a type of audio data.

In some examples, the sequence of audio data encodes music, sound effects, extended reality (XR) audio, or a combination thereof.

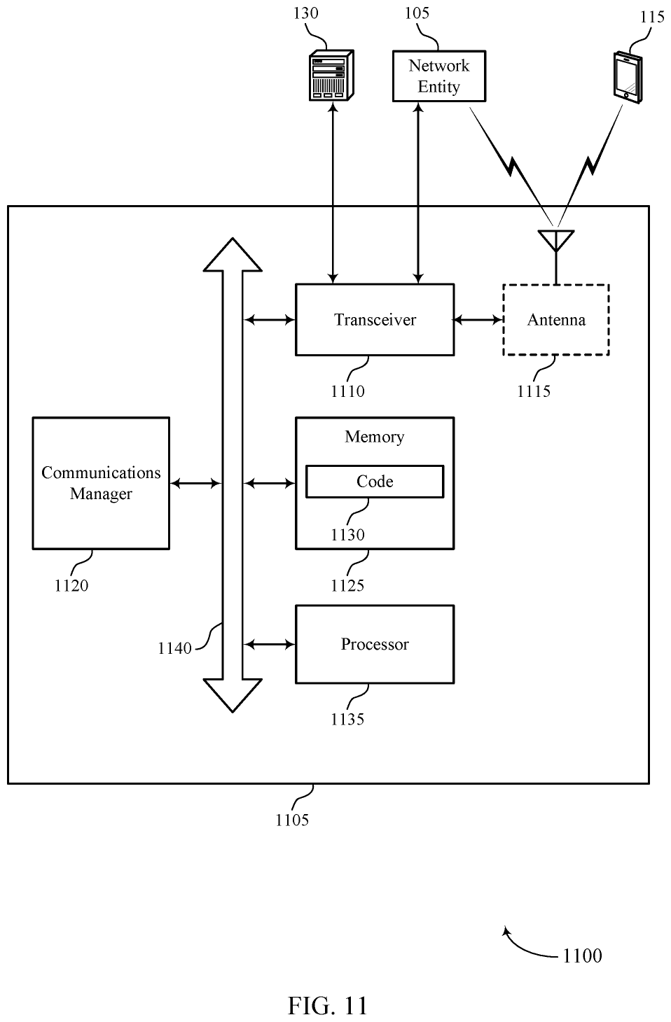

FIG. 11 illustrates a diagram of a system 1100 including a device 1105 that supports using a semantic model for extended reality data for network efficient operations in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting using a semantic model for extended reality data for network efficient operations). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a media server in accordance with examples as disclosed herein. For example, the communications manager 1120 may be configured as or otherwise support a means for outputting an indication of a semantic model to use for processing data packets to be received at a UE, where the semantic model is determinative of incomplete audio data based on a meaning of known audio data. The communications manager 1120 may be configured as or otherwise support a means for encoding, using the semantic model, a sequence of audio data into a set of data packets. The communications manager 1120 may be configured as or otherwise support a means for outputting at least a subset of the set of data packets.

By including or configuring the communications manager 1120 in accordance with examples as described herein, the device 1105 may support techniques for more efficient utilization of communication resources by limiting or reducing the need for retransmission of data (e.g., audio data). By using the semantic model, the devices may generate or predict the audio data that corresponds to dropped, missing, or undecoded packets.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of using a semantic model for extended reality data for network efficient operations as described herein, or the processor 1135 and the memory 1125 may be otherwise configured to perform or support such operations.

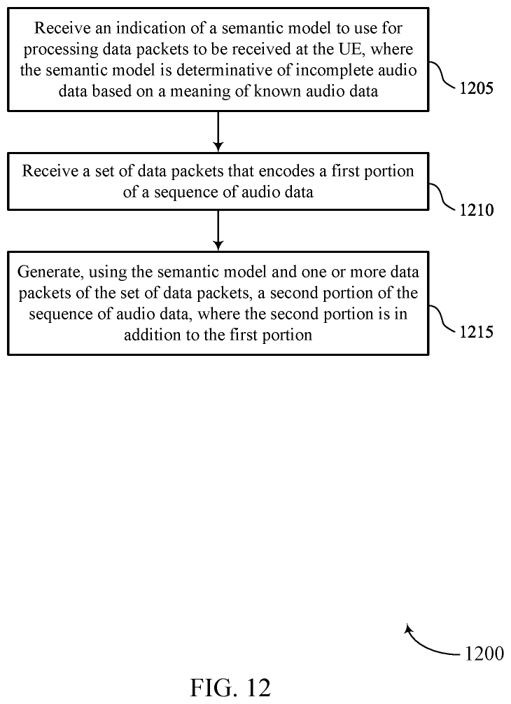

FIG. 12 illustrates a flowchart showing a method 1200 that supports using a semantic model for extended reality data for network efficient operations in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving an indication of a semantic model to use for processing data packets to be received at the UE, where the semantic model is determinative of incomplete audio data based on a meaning of known audio data. The operations of 1205 may be performed in accordance with examples as disclosed herein. In some examples, aspects of the operations of 1205 may be performed by a semantic model indication interface 625 as described with reference to FIG. 6.

At 1210, the method may include receiving a set of data packets that encodes a first portion of a sequence of audio data. The operations of 1210 may be performed in accordance with examples as disclosed herein. In some examples, aspects of the operations of 1210 may be performed by a packet interface 630 as described with reference to FIG. 6.

At 1215, the method may include generating, using the semantic model and one or more data packets of the set of data packets, a second portion of the sequence of audio data, where the second portion is in addition to the first portion. The operations of 1215 may be performed in accordance with examples as disclosed herein. In some examples, aspects of the operations of 1215 may be performed by an audio data generation component 635 as described with reference to FIG. 6.

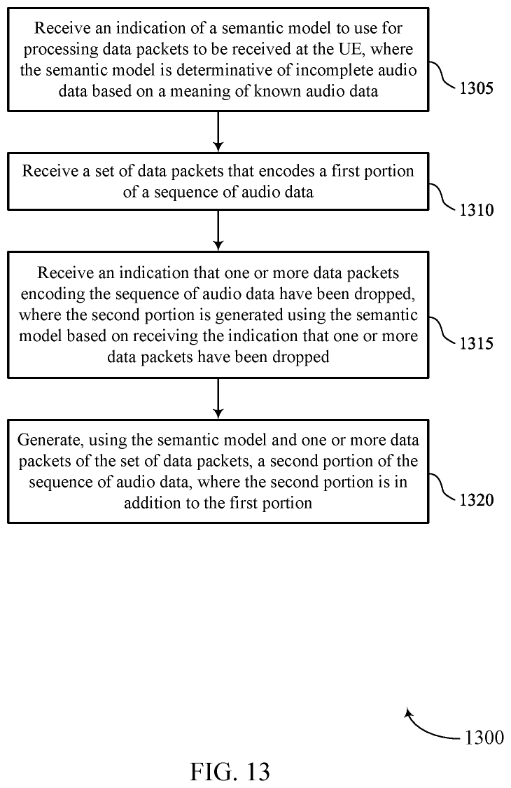

FIG. 13 illustrates a flowchart showing a method 1300 that supports using a semantic model for extended reality data for network efficient operations in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a semantic model to use for processing data packets to be received at the UE, where the semantic model is determinative of incomplete audio data based on a meaning of known audio data. The operations of 1305 may be performed in accordance with examples as disclosed herein. In some examples, aspects of the operations of 1305 may be performed by a semantic model indication interface 625 as described with reference to FIG. 6.

At 1310, the method may include receiving a set of data packets that encodes a first portion of a sequence of audio data. The operations of 1310 may be performed in accordance with examples as disclosed herein. In some examples, aspects of the operations of 1310 may be performed by a packet interface 630 as described with reference to FIG. 6.

At 1315, the method may include receiving an indication that one or more data packets encoding the sequence of audio data have been dropped, where the second portion is generated using the semantic model based on receiving the indication that one or more data packets have been dropped. The operations of 1315 may be performed in accordance with examples as disclosed herein. In some examples, aspects of the operations of 1315 may be performed by a packet dropped indication component 640 as described with reference to FIG. 6.

At 1320, the method may include generating, using the semantic model and one or more data packets of the set of data packets, a second portion of the sequence of audio data, where the second portion is in addition to the first portion. The operations of 1320 may be performed in accordance with examples as disclosed herein. In some examples, aspects of the operations of 1320 may be performed by an audio data generation component 635 as described with reference to FIG. 6.

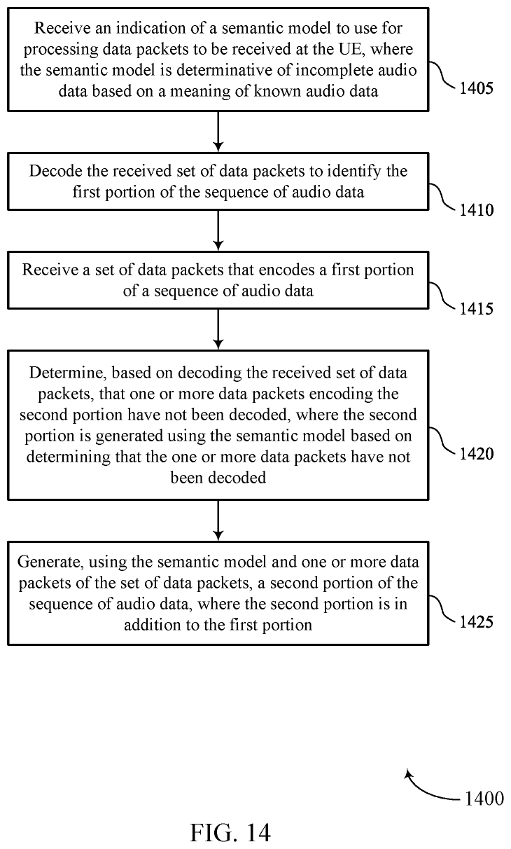

FIG. 14 illustrates a flowchart showing a method 1400 that supports using a semantic model for extended reality data for network efficient operations in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a semantic model to use for processing data packets to be received at the UE, where the semantic model is determinative of incomplete audio data based on a meaning of known audio data. The operations of 1405 may be performed in accordance with examples as disclosed herein. In some examples, aspects of the operations of 1405 may be performed by a semantic model indication interface 625 as described with reference to FIG. 6.

At 1410, the method may include decoding the received set of data packets to identify the first portion of the sequence of audio data. The operations of 1410 may be performed in accordance with examples as disclosed herein. In some examples, aspects of the operations of 1410 may be performed by a packet decoding component 645 as described with reference to FIG. 6.

At 1415, the method may include receiving a set of data packets that encodes a first portion of a sequence of audio data. The operations of 1415 may be performed in accordance with examples as disclosed herein. In some examples, aspects of the operations of 1415 may be performed by a packet interface 630 as described with reference to FIG. 6.

At 1420, the method may include determining, based on decoding the received set of data packets, that one or more data packets encoding the second portion have not been decoded, where the second portion is generated using the semantic model based on determining that the one or more data packets have not been decoded. The operations of 1420 may be performed in accordance with examples as disclosed herein. In some examples, aspects of the operations of 1420 may be performed by a packet decoding component 645 as described with reference to FIG. 6.

At 1425, the method may include generating, using the semantic model and one or more data packets of the set of data packets, a second portion of the sequence of audio data, where the second portion is in addition to the first portion. The operations of 1425 may be performed in accordance with examples as disclosed herein. In some examples, aspects of the operations of 1425 may be performed by an audio data generation component 635 as described with reference to FIG. 6.

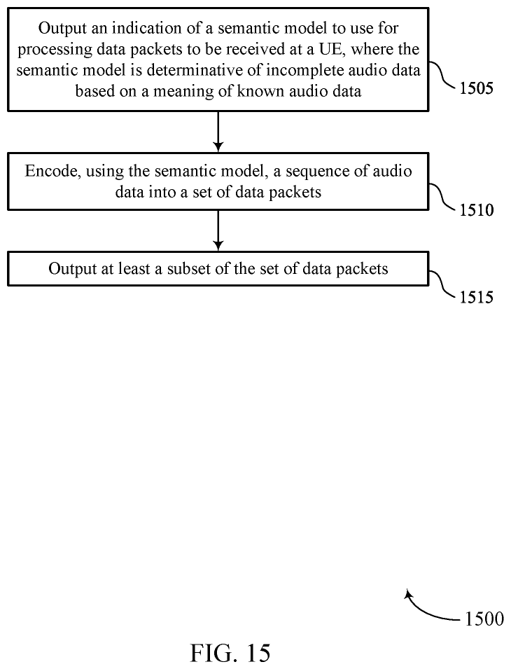

FIG. 15 illustrates a flowchart showing a method 1500 that supports using a semantic model for extended reality data for network efficient operations in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting an indication of a semantic model to use for processing data packets to be received at a UE, where the semantic model is determinative of incomplete audio data based on a meaning of known audio data. The operations of 1505 may be performed in accordance with examples as disclosed herein. In some examples, aspects of the operations of 1505 may be performed by a semantic model indication interface 1025 as described with reference to FIG. 10.

At 1510, the method may include encoding, using the semantic model, a sequence of audio data into a set of data packets. The operations of 1510 may be performed in accordance with examples as disclosed herein. In some examples, aspects of the operations of 1510 may be performed by an audio data encoding component 1030 as described with reference to FIG. 10.

At 1515, the method may include outputting at least a subset of the set of data packets. The operations of 1515 may be performed in accordance with examples as disclosed herein. In some examples, aspects of the operations of 1515 may be performed by a packet communication interface 1035 as described with reference to FIG. 10.

The following provides an overview of aspects of the present disclosure:

Aspect 1: A method for wireless communications at a UE, comprising: receiving an indication of a semantic model to use for processing data packets to be received at the UE, wherein the semantic model is determinative of incomplete audio data based on a meaning of known audio data; receiving a set of data packets that encodes a first portion of a sequence of audio data; and generating, using the semantic model and one or more data packets of the set of data packets, a second portion of the sequence of audio data, wherein the second portion is in addition to the first portion.

Aspect 2: The method of aspect 1, further comprising: receiving an indication that one or more data packets encoding the sequence of audio data have been dropped, wherein the second portion is generated using the semantic model based at least in part on receiving the indication that one or more data packets have been dropped.

Aspect 3: The method of aspect 2, wherein receiving the indication that the one or more data packets have been dropped comprises: receiving, in one or more data packets of the received set of data packets, a field including the indication that the one or more data packets have been dropped.

Aspect 4: The method of aspect 3, wherein the field comprises a bit flag.

Aspect 5: The method of any of aspects 1 through 4, further comprising: decoding the received set of data packets to identify the first portion of the sequence of audio data; and determining, based at least in part on decoding the received set of data packets, that one or more data packets encoding the second portion have not been decoded, wherein the second portion is generated using the semantic model based at least in part on determining that the one or more data packets have not been decoded.

Aspect 6: The method of aspect 5, further comprising: refraining from transmitting a retransmission request for the one or more data packets encoding the second portion.

Aspect 7: The method of any of aspects 1 through 6, further comprising: receiving, in one or more data packets of the set of data packets, an indication that the one or more data packets are usable to generate the second portion using the semantic model, wherein the second portion is generated using the semantic model based at least in part on receiving the indication that the one or more data packets are usable.

Aspect 8: The method of aspect 7, wherein receiving the indication that the one or more data packets are usable comprises: receiving, in the one or more data packets, a respective field including the indication that a corresponding data packet is usable.

Aspect 9: The method of any of aspects 1 through 8, wherein generating the second portion comprises: using audio data of the first portion that is prior to the second portion to generate the second portion using the semantic model.

Aspect 10: The method of any of aspects 1 through 9, further comprising: receiving a second set of data packets that encode a sequence of video data; and generating the second portion based at least in part on processing the sequence of video data using the semantic model.

Aspect 11: The method of aspect 10, wherein the second portion is generated based at least in part on an environment encoded in the sequence of video data, objects displayed in the environment, arrangements of objects displayed in the environment, or any combination thereof.

Aspect 12: The method of any of aspects 1 through 11, wherein receiving the indication of the semantic model comprises: receiving the indication of the semantic model during a communication session setup procedure.

Aspect 13: The method of any of aspects 1 through 12, wherein receiving the indication of the semantic model comprises: receiving the indication of the semantic model via session initiation protocol (SIP) signaling.

Aspect 14: The method of any of aspects 1 through 13, wherein receiving the indication of the semantic model comprises: receiving the indication of an n-gram semantic model.

Aspect 15: The method of aspect 14, wherein the indication includes a value for n of the n-gram semantic model.

Aspect 16: The method of any of aspects 1 through 15, wherein receiving the indication of the semantic model comprises: receiving the indication of the semantic model that corresponds to a genre of music or a type of audio data.

Aspect 17: The method of any of aspects 1 through 16, wherein the sequence of audio data encodes music, sound effects, extended reality (XR) audio, or a combination thereof.

Aspect 18: A method for wireless communications at a media server, comprising: outputting an indication of a semantic model to use for processing data packets to be received at a UE, wherein the semantic model is determinative of incomplete audio data based on a meaning of known audio data; encoding, using the semantic model, a sequence of audio data into a set of data packets; and outputting at least a subset of the set of data packets.

Aspect 19: The method of aspect 18, further comprising: outputting an indication that one or more data packets encoding the sequence of audio data have been dropped.

Aspect 20: The method of aspect 19, wherein outputting the indication that the one or more data packets have been dropped comprises: including, in one or more data packets of the output set of data packets, a field including the indication that the one or more data packets have been dropped.

Aspect 21: The method of aspect 20, wherein the field comprises a bit flag.

Aspect 22: The method of any of aspects 18 through 21, wherein encoding the sequence of audio data comprises: determining whether audio data of a first data packet of the set of data packets is predictable using the semantic model; and refraining from outputting the first data packet based at least in part on determining that the first data packet is predictable.

Aspect 23: The method of aspect 22, wherein determining whether the audio data of the first data packet is predictable comprises: determining whether a probability of predicting the audio data using one or more second data packets of the set of data packets as input into the semantic model exceeds a threshold probability.

Aspect 24: The method of any of aspects 18 through 23, further comprising: receiving, at a first layer of the media server and from a second layer, an indication to discard a first data packet of the set of data packets; and refraining from outputting the first data packet based at least in part on receiving the indication to discard the first data packet.

Aspect 25: The method of aspect 24, wherein the second layer is a radio resource control layer.

Aspect 26: The method of any of aspects 18 through 25, further comprising: outputting, in one or more data packets of the set of data packets, an indication that the one or more data packets are usable to generate a portion of the sequence of audio data using the semantic model.

Aspect 27: The method of aspect 26, wherein outputting the indication that the one or more data packets are usable comprises: including, in the one or more data packets, a respective field including the indication that a corresponding data packet is usable.

Aspect 28: The method of any of aspects 18 through 27, further comprising: refraining, based at least in part on outputting the indication of the semantic model, from retransmitting one or more data packets of the set of data packets.

Aspect 29: The method of any of aspects 18 through 28, further comprising: determining, based at least in part on outputting the indication of the semantic model, that a retransmission request for one or more data packets of the set of data packets is not received.

Aspect 30: The method of any of aspects 18 through 29, further comprising: outputting a second set of data packets that encode a sequence of video data, wherein the semantic model is configured to process the sequence of video data to generate a portion of the sequence of audio data.

Aspect 31: The method of any of aspects 18 through 30, wherein outputting the indication of the semantic model comprises: outputting the indication of the semantic model during a communication session setup procedure.

Aspect 32: The method of any of aspects 18 through 31, wherein outputting the indication of the semantic model comprises: outputting the indication of the semantic model via session initiation protocol (SIP) signaling.

Aspect 33: The method of any of aspects 18 through 32, wherein outputting the indication of the semantic model comprises: outputting the indication of an n-gram semantic model.

Aspect 34: The method of aspect 33, wherein the indication includes a value for n of the n-gram semantic model.

Aspect 35: The method of any of aspects 18 through 34, wherein outputting the indication of the semantic model comprises: outputting the indication of the semantic model that corresponds to a genre of music or a type of audio data.

Aspect 36: The method of any of aspects 18 through 35, wherein the sequence of audio data encodes music, sound effects, extended reality (XR) audio, or a combination thereof.

Aspect 37: An apparatus for wireless communications at a UE, comprising a processor; memory coupled with the processor; and instructions stored in the memory and executable by the processor to cause the apparatus to perform a method of any of aspects 1 through 17.

Aspect 38: An apparatus for wireless communications at a UE, comprising at least one means for performing a method of any of aspects 1 through 17.

Aspect 39: A non-transitory computer-readable medium storing code for wireless communications at a UE, the code comprising instructions executable by a processor to perform a method of any of aspects 1 through 17.

Aspect 40: An apparatus for wireless communications at a media server, comprising a processor; memory coupled with the processor; and instructions stored in the memory and executable by the processor to cause the apparatus to perform a method of any of aspects 18 through 36.

Aspect 41: An apparatus for wireless communications at a media server, comprising at least one means for performing a method of any of aspects 18 through 36.

Aspect 42: A non-transitory computer-readable medium storing code for wireless communications at a media server, the code comprising instructions executable by a processor to perform a method of any of aspects 18 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving an indication of a semantic model to use for processing data packets to be received at the UE, wherein the semantic model is determinative of incomplete audio data based on a meaning of known audio data;
receiving a set of data packets that encodes a first portion of a sequence of audio data; and
generating, using the semantic model and one or more data packets of the set of data packets, a second portion of the sequence of audio data, wherein the second portion is in addition to the first portion.

2. The method of claim 1, further comprising:
receiving an indication that one or more data packets encoding the sequence of audio data have been dropped, wherein the second portion is generated using the semantic model based at least in part on receiving the indication that one or more data packets have been dropped.

3. The method of claim 2, wherein receiving the indication that the one or more data packets have been dropped comprises:
receiving, in one or more data packets of the received set of data packets, a field including the indication that the one or more data packets have been dropped.

4. The method of claim 3, wherein the field comprises a bit flag.

5. The method of claim 1, further comprising:
decoding the received set of data packets to identify the first portion of the sequence of audio data; and
determining, based at least in part on decoding the received set of data packets, that one or more data packets encoding the second portion have not been decoded, wherein the second portion is generated using the semantic model based at least in part on determining that the one or more data packets have not been decoded.

6. The method of claim 5, further comprising:
refraining from transmitting a retransmission request for the one or more data packets encoding the second portion.

7. The method of claim 1, further comprising:
receiving, in one or more data packets of the set of data packets, an indication that the one or more data packets are usable to generate the second portion using the semantic model, wherein the second portion is generated using the semantic model based at least in part on receiving the indication that the one or more data packets are usable.

8. The method of claim 7, wherein receiving the indication that the one or more data packets are usable comprises:
receiving, in the one or more data packets, a respective field including the indication that a corresponding data packet is usable.

9. The method of claim 1, wherein generating the second portion comprises:
using audio data of the first portion that is prior to the second portion to generate the second portion using the semantic model.

10. The method of claim 1, further comprising:
receiving a second set of data packets that encode a sequence of video data; and
generating the second portion based at least in part on processing the sequence of video data using the semantic model.

11. The method of claim 10, wherein the second portion is generated based at least in part on an environment encoded in the sequence of video data, objects displayed in the environment, arrangements of objects displayed in the environment, or any combination thereof.

12. The method of claim 1, wherein receiving the indication of the semantic model comprises:
receiving the indication of the semantic model during a communication session setup procedure.

13. The method of claim 1, wherein receiving the indication of the semantic model comprises:
receiving the indication of the semantic model via session initiation protocol (SIP) signaling.

14. The method of claim 1, wherein receiving the indication of the semantic model comprises:
receiving the indication of an n-gram semantic model.

15. The method of claim 14, wherein the indication includes a value for n of the n-gram semantic model.

16. The method of claim 1, wherein receiving the indication of the semantic model comprises:
receiving the indication of the semantic model that corresponds to a genre of music or a type of audio data.

17. The method of claim 1, wherein the sequence of audio data encodes music, sound effects, extended reality (XR) audio, or a combination thereof.

18. A method for wireless communications at a media server, comprising:
outputting an indication of a semantic model to use for processing data packets to be received at a user equipment (UE), wherein the semantic model is determinative of incomplete audio data based on a meaning of known audio data;
encoding, using the semantic model, a sequence of audio data into a set of data packets; and
outputting at least a subset of the set of data packets.

19. The method of claim 18, further comprising:
outputting an indication that one or more data packets encoding the sequence of audio data have been dropped.

20. The method of claim 19, wherein outputting the indication that the one or more data packets have been dropped comprises:
including, in one or more data packets of the output set of data packets, a field including the indication that the one or more data packets have been dropped.

21. The method of claim 20, wherein the field comprises a bit flag.

22. The method of claim 18, wherein encoding the sequence of audio data comprises:
determining whether audio data of a first data packet of the set of data packets is predictable using the semantic model; and
refraining from outputting the first data packet based at least in part on determining that the first data packet is predictable.

23. The method of claim 22, wherein determining whether the audio data of the first data packet is predictable comprises:
determining whether a probability of predicting the audio data using one or more second data packets of the set of data packets as input into the semantic model exceeds a threshold probability.

24. The method of claim 18, further comprising:
receiving, at a first layer of the media server and from a second layer, an indication to discard a first data packet of the set of data packets; and
refraining from outputting the first data packet based at least in part on receiving the indication to discard the first data packet.

25. The method of claim 24, wherein the second layer is a radio resource control layer.

26. The method of claim 18, further comprising:
outputting, in one or more data packets of the set of data packets, an indication that the one or more data packets are usable to generate a portion of the sequence of audio data using the semantic model.

27. The method of claim 26, wherein outputting the indication that the one or more data packets are usable comprises:
including, in the one or more data packets, a respective field including the indication that a corresponding data packet is usable.

28. The method of claim 18, further comprising:
refraining, based at least in part on outputting the indication of the semantic model, from retransmitting one or more data packets of the set of data packets.

29. An apparatus for wireless communications at a user equipment (UE), comprising:
a processor;
memory coupled with the processor; and
instructions stored in the memory and executable by the processor to cause the apparatus to:
receive an indication of a semantic model to use for processing data packets to be received at the UE, wherein the semantic model is determinative of incomplete audio data based on a meaning of known audio data;
receive a set of data packets that encodes a first portion of a sequence of audio data; and
generate, using the semantic model and one or more data packets of the set of data packets, a second portion of the sequence of audio data, wherein the second portion is in addition to the first portion.

30. An apparatus for wireless communications at a media server, comprising:
a processor;
memory coupled with the processor; and
instructions stored in the memory and executable by the processor to cause the apparatus to:
output an indication of a semantic model to use for processing data packets to be received at a user equipment (UE), wherein the semantic model is determinative of incomplete audio data based on a meaning of known audio data;
encode, using the semantic model, a sequence of audio data into a set of data packets; and
output at least a subset of the set of data packets.
